(19) United States
(12) Patent Application Publication
(10) Pub. No.: US 2005/0036651 A1
(43) Pub. Date: Feb. 17, 2005

(54) Digital anti&minus forging method

(76) Inventor: Tian Wen, Shanghai (CN)

Correspondence Address: SQUIRE, SANDERS & DEMPSEY L.L.P., 1 MARITIME PLAZA, SUITE 300, SAN FRANCISCO, CA, 94111, US

(21) Appl. No.: 10/496,926

(22) PCT Filed: Nov. 18, 2002
(86) PCT No.: PCT/CN02/00820

(30) Foreign Application Priority Data
Nov. 30, 2001 (CN) 011323728

(51) Int. Cl. G06K 9/00

(52) U.S. Cl. 382/100

(57) ABSTRACT

The present invention relates to a technique of digital anti-forging based on the digital watermarking, belonging to the field of image processing and information security. Using the technique of the digital watermarking can make digital signature or other information figurize. The present invention can combine with the existing certificate, handwriting signature, stamper and bar code, and make digital signature syncretize to digital or paper files in order to protect and prevent that important file, business contact, trademark and personal certificate are counterfeited, and it is a novel digital anti-forging solution.

### TECHNICAL FIELD

This invention is a digital anti-counterfeit (anti-forging) technology based on digital watermarking and falls into the field of image processing and information security.

### BACKGROUND TECHNOLOGY

Digital watermarking is to add some digital information into multimedia data (such as image, sound and video signal) to enable functions such as file authenticity detection and copyright protection. The embedded watermark information is hidden in the host file, having no effect on visibility and intactness of the original file. Generally speaking, digital watermark meets the following basic requirements: (1) vindicability; (2) intangibility; (3) robustness. In most cases, we hope that the added information is unperceivable (in some particular cases where visible digital watermark is used, it is not required that copyright protection symbol be hidden) and that the attacker won't be able to remove the watermark without deteriorating quality of the data itself. The impetus for developing the digital watermark technology is to protect copyright of multimedia data, but people have found some other important applications of digital watermark, for example: (1) interference-free communication means for military and intelligent organizations; (2) data-hiding communication technology for state security departments; (3) special information transmission with conventional communication equipment; (4) government departments' filter and control, etc. of anonymous and encrypted information on the internet; (5) data detection and network verification in e-commerce; (6) e-mail anti-counterfeit and data certification, etc.

According to watermark embedding method, current digital watermark technology can be roughly divided into two categories: spatial domain technology (i.e. watermark directly added onto the gray value) and transform domain technology (i.e. watermark added onto coefficient of the transform domain of the image after certain transformation of the image). Different watermark algorithms have different characteristics and apply in different situations. For the current watermark technology, however, there is still much to be done in terms of embedding capacity, construction of theory model and robustness.

The following five comparable technical documents are available:
[1] J. M. Acken, How watermarking adds value to digital content, Communications of the ACM, Vol.41, No.7, pp.74-77, 1998.
[2] F. A. P. Petitcolas, R. J. Anderson and M. G. Kuhn, Information hiding—a survey, Proc, of the IEEE, special issue on protection of multimedia content, May 1999.
[3] N. F. Johnson and S. Jajodia, Exploring steganography: seeing the unseen, IEEE Computer, Vol.31, No.2, pp.26-34, February 1998.
[4] R. J. Aderson and F. A. P. Petitcolas, On the limits of steganography, IEEE Journal on special areas in communications, Vol.16, No.4, pp.463-478, May, 1998.
[5] Joseph J. K. O'Ruanaidh and Gabriella Csurka, A Bayesian approach to spread spectrum watermark detection and secure copyright protection for digital image libraries, IEEE Conf. on Computer Vision and Pattern Recognition (CVPR'99), Fort Collins, Colo., USA, Jun. 23-25, 1999.

### SUMMARY OF INVENTION

This invention provides a new digital anti-counterfeit and verification method that adopts digital watermark technology. This invention can effectively solve the anti-counterfeit problem of credentials, business documents, contracts and any legal document. The basic principle of this method is to extract digital signature information from the original file, and then embed it as digital watermark into the original file. The file thus processed integrates with the embedded watermark. The file thus processed is self-contained, i.e. it contains signature information of its maker, thus greatly improving its anti-counterfeit performance. Secondly, this method applies to both digital files and paper files. Ordinary paper files added with digital watermark ID of this algorithm can have complete legal effect of seals and written signatures and won't be counterfeited even after printing, copying or faxing. This method can be directly applied in text verification and anti-counterfeit for digital seals, digital trademarks, digital authentication, etc.

Technical points of this invention are:
1: Digital image watermark algorithm based on block DCT Digital watermarking is to add some digital information into multimedia data (such as image, sound and video signal), so as to protect copyright, etc. Common digital watermark algorithms include two basic aspects: watermark embedding and watermark extraction or detection. See FIG. 1˜3 for embedding algorithm, detection algorithm and examples.

Watermark embedding model given in this invention is additive block embedding algorithm. Block size depends on specific application, for example, considering in JPEG standard, block size is set to K_{B}=8. The embedding process is to firstly divide the image into K×K_{B} blocks, perform discrete cosine transform (DCT) for each image block, then select characteristic vector from transform coefficient. Coefficient selection is similar to JPEG algorithm, performing zigzag scanning of the entire block and removing direct component to obtain first K maximal. coefficients, so characteristic vector is C={cₖ,k=1,2, . . . ,K} . If watermark {wₖ} is embedded into characteristic vector {cₖ}, new characteristic vector \overline{C}={\overline{c}ₖ} εF^{K} can be obtained from the following formula:
\overline{c}ₖ=cₖ+aₖwₖ, k=1,2, . . . ,K (1)
in which, scalar factor { aₖ} is a constant vector that controls watermark embedding strength or energy. Replace the original characteristic vector {\overline{c} ₖ} with newly obtained characteristic vector {cₖ} to obtain new transform domain matrix \overline{B}_{b}, then reconstruct image B_{b}. If similar embedding process is gone through for each image block, the entire image can be obtained by putting together the watermarked images reconstructed.

Linear relevant examination is made for watermark detection model on the basis of additive watermark model. For given watermarked image B={bᵢⱼ} εF^{M×N} and watermark W={wₖ}, we obtain characteristic vector \overline{C}={\overline{c}ₖ} ε\overline{B} (here, since position of DCT coefficient is fixed, original image is unnecessary when extracting characteristic vector \overline{C}), then value of scalar quantity Z is calculated according to the following formula:

$$Z = {\sum }_{k} {\tilde{c}}_{k} {w}_{k} \qquad ( 2 )$$

If characteristic vector \overline{C} of the representative image is regarded as observation noise and watermark W={wₖ} as signal, relevant indication given by formula (2) is a linear matched filtering. Assume DCT coefficient of image complies with Laplacian distribution statistics model, we have optimum method (symbol related detection) to determine signal in Laplacian noise, i.e.:

$$Z = {\sum }_{k} {w}_{k} sgn ( {\tilde{c}}_{k} ) \qquad ( 3 )$$

For image watermark algorithm of each K_{B}×K_{B} block, it can be regarded as watermark verification instead of watermark extraction algorithm, i.e. judging whether image block contains watermark. In fact it can also be regarded as a watermark recovery algorithm of one bit information. Given characteristic vector of image block \overline{C} and watermark W, if detected image block is not watermarked, formula (3) changes into:

$$z = {\sum }_{k} sgn ( {\tilde{c}}_{k} ) {w}_{k} = {\sum }_{k} sgn ( {c}_{k} {w}_{k} ⩽ δ \qquad ( 4 )$$

Trueness of (4) implies an assumption, i.e. characteristic vector and watermark are independent from each other. Under this assumption, inner product of the two can be deemed as smaller than a positive number δ. If image block contains watermark, then we have:

$$Z = {\sum }_{k} sgn ( {\tilde{c}}_{k} ) {w}_{k} = {\sum }_{k} {w}_{k} \cdot sgn ( {c}_{k} + {a}_{k} {w}_{k} ) \qquad ( 5 )$$
Notice that

$$sgn ( {c}_{i} + {a}_{i} {w}_{i} ) = \{ \begin{matrix}sgn ( {c}_{i} ) , & \vert {c}_{i} \vert \geq \vert {a}_{i} {w}_{i} \vert \\ sgn ( {a}_{i} {w}_{i} ) , & \vert {a}_{i} {w}_{i} \vert \geq \vert {c}_{i} \vert\end{matrix} \qquad ( 6 )$$
then (5) can be decomposed into:

$$\begin{matrix}Z = {\sum }_{k} sgn ( {\tilde{c}}_{k} ) {w}_{k} \\ = {\sum }_{k} {w}_{k} \cdot sgn ( {c}_{k} + {a}_{k} {w}_{k} ) \\ = {\sum }_{kl} sgn ( {c}_{i} ) {w}_{i} \\ = {\sum }_{kh} sgn ( {w}_{i} ) • {w}_{i} ⩽ δ + {\sum }_{kh} \vert {W}_{kh} \vert\end{matrix} \qquad ( 7 )$$
among which, k=kl+kh.
In consideration of particularity of image block, image energy concentrates on several DCT coefficients, so we superpose watermark on medium and high frequency of image block. In this way, watermark algorithm will acquire certain robustness but exert little effect on image quality. So it is reasonable to have the above decomposition. Perform the following hypothesis test:
   H₁: Z=m+e(t)
   H₀: Z=e(t) (8)
among which,

$$m = {\sum }_{kh} \vert {W}_{kh} \vert$$

is a constant while e(t) indicates image distortion. Here, image distortion (ex. image filtering, superposing noise, geometric conversion, etc.) is regarded as noise and we assume that it complies with Gaussian distribution, i.e. e(t)˜N(μ,σ²). Then we calculate false alarm probability and signal misidentification probability according to Neymann-Pearson criterion.
2: Discrete digital watermark model based on binary-level and multi-level -image For binary-level-or multi-level discrete image (i.e. black and white image, ex. scanned seal, barcode, etc.), construction of watermark algorithm is a little different from watermark method for previous gray-scale images. With image quality guaranteed, in order to assure higher robustness, it is necessary to directly convert pixel points of the image on image domain.

Assume that original image A is a two-valued image (0 for black, 255 for white), watermark information is a two-valued serial (length N) W={w_{j,}j=,1,2, . . . N} ε{0,1}. Different from the previous image of ordinary gray scale, no information can be embedded into white background, because human visual system is very sensitive to change of pixel value in white background. Watermark information can only be embedded into pattern of the image (i.e. black part). Therefore, capacity N of watermark information depends on specific image content. Here, we always deem that background of the image is white and pattern is black. Digital watermark embedding algorithm is as follows:
(1) initialize watermark parameter K (block size), Q (image quality factor) and image size;
(2) scan the image from top to bottom; calculate scalar value

$${S}_{i , j}^{k} = {\sum }_{k} {\sum }_{k} {a}_{i + k , j + k} k = 1 , 2 , … , k \qquad ( 9 )$$
(3) when S_{i,j}^{k} value is greater than 128K²/Q, each block is embedded with one bit information: a _{i+k,j+k}=0 if wⱼ=0
   a_{i+k, j=k}=128 if wⱼ=1 (10)
   among which, k=1,2, . . . ,K, j=1,2, . . . ,N

Block shape can be square, round point or other feature pattern. Number of pixel points in each block depends on concrete application. The less pixel points, the more blocks, and the more embeddable information. Each block can be embedded with information of one bit or multiple bits according to different needs (the higher the image gray scale, the more the bits, and if block image has only one gray scale, each block can only be embedded with information of one bit). Since background is generally white, and human eye is very sensitive to low-frequency part of the image (ex. white background), background of the image (i.e. parts where light reflection rate is higher, ex. white “blank”) is reserved without change. In case of embedding only one bit for each block, embedding method is: if embedded watermark information is “1”, pixel value of corresponding block is changed to pre-defined color value; if embedded information is “0”, the block maintains original color value without change. For each block, pre-defined color value determines visibility of watermark information (the closer pre-defined value is to barcode element color, the more difficult watermark can be perceived, and the more difficult watermark can be extracted), pre-defined color value (i.e. gray scale of block image) determines quantity of information in the watermark embedded (in case of multiple predefined color values, multi-bit information can be embedded).

Watermark detection algorithm is a simple reverse process. For image watermark algorithm of each K_{B}×K_{B} block, it can be regarded as watermark verification instead of watermark extraction algorithm, i.e. judging whether image block contains watermark. In fact, it can also be regarded as watermark recovery algorithm of bit information. Therefore, if there are N image blocks, the image can be embedded and detected with N bits of information.

In order to improve robustness of watermark algorithm, in this invention the following measures are adopted: firstly preprocess the input watermarked image, thus reducing negative effect on watermark detection due to image distortion caused by image login through printer, scanner or web cam; secondly watermark information contains error correcting code (ex. BCH or RS) and check code (ex. 32 bit CRC code), which guarantees reliable and unbroken extraction of watermark information even when barcode watermark is blurred.

3: Digital Signature

In order to verify authenticity of a file or letter, a conventional practice is that relevant personnel sign or seal on the file or letter. It has the effect of certification, approval and validation. Generally, written signature meets the following five principles: (1) signature can be confirmed, i.e. when a file carries your signature, others believe it is issued from you; (2) signature cannot be counterfeited, i.e. signature is credence of the signer; (3) signature cannot be used repeatedly, i.e. nobody can misappropriate the file with your signature elsewhere; (4) signed file cannot be falsified; (5) signature is undeniable, i.e. signer cannot deny his act of signing on the file. In fact, the above several points cannot be 100% satisfied. Signature can be counterfeited, transferred from one file to another, and signed file can also be falsified. But the problem is that all these means of fraud are extremely difficult, and easy to be discovered. So basically we can say that written signature meets the above five major requirements.

Nevertheless, digital signature is closely related with development of modern cryptology. Encryption and decryption process can be briefly described as follows: refer to the original file as P, encrypted file as C; encryption algorithm as E, then E(P)=C, i.e. P turns into C after encryption. If we refer to decryption algorithm as D, then D(C)=P, i.e. C turns into P after decryption, and the whole process can be written as D(E(P))=P. Modern encryption and decryption algorithm is generally public, so a so-called Key is necessary, referred to as K, i.e. encryption and decryption is a combination of algorithm and Key. Algorithm can be made public while Key cannot, thus still meeting the requirement of confidentiality. In such case, its flow chart is shown in FIG. 4, i.e. Eₖ(P)=C, Dₖ(C)=P, Dₖ(Eₖ(P)=P.

Key used for encryption and decryption in the above algorithm is the same. Such algorithm is called symmetric algorithm while another algorithm uses different keys to encrypt and decrypt information, which is called public key algorithm. Keys (k1, k2) appear in pairs, and a file encrypted with one key can be decrypted only with another key. One of the two keys is confidential, which is called Private Key, and another is called Public Key. As shown in FIG. 5, Eₖ₁(P)=C, Dₖ₂(C)=P, Dₖ₂(Eₖ₁(P))=P.

On the above basis, we give the file verification method of digital identification system: firstly apply Hash function to the file, generate a very short (only dozens or hundreds of bits) output H (Hash value) from the original file P through a one-way Hash function, i.e. Hash (P)=H, here H can be generated from P very quickly, but it is almost impossible to generate P from H, then apply public key algorithm on H to generate “digital signature” S, referred to as Eₖ₁(H)=S. k1 is public key of A, A passes (P,S) to B, after receiving (P,S) B needs to verify that S is signature of A. If there is H1=H2, i.e. Dₖ₂(S)=Hash(P), we deem that S is signature of A. See FIG. 6 for schematic diagram.

Actually, digital anti-counterfeit method is composed of two parts. The first part is the fabrication end of anti-counterfeit file, whose process is as follows: (FIG. 7)
(1) convert content of original file into corresponding Hash value through Hash function (also become digital summary of the file);
(2) obtain digital signature of original file from Hash value through public key encryption algorithm;
(3) embed the digital signature as watermark information into original file to obtain watermarked file;
(4) issue file with digital signature watermark and public key of the maker;

The second part is validation end of the file, whose process is as follows: (FIG. 8)
(1) convert content of watermarked file into Hash value Hash #1 through Hash function;
(2) perform watermark detection, extract watermark information from watermarked file (i.e. digital signature);
(3) decrypt signature information with public key issued by the file owner and obtain another Hash value Hash #2;
(4) compare two Hash values, and if they are consistent, the file can be confirmed authentic, otherwise it is counterfeited;

Compared with existing anti-counterfeit technology, this invention has the following advantages:

Based on digital watermark technology, this invention converts digital signature into graphics and ensures safety of anti-counterfeit technology by taking advantage of non-counterfeitability of digital signature. Digital signature is used to ensure information integrity and confirm ID of the information sender. In e-commerce, online payment can be made safely and conveniently, and measures for safety, integrity, ID verification mechanism and undeniability of transactions during data transmission are implemented mostly by means of safety verification. Electronic signature can further facilitate enterprises and consumers in doing business online and enable enterprises and consumers to benefit from each other. For example, business users don't have to sign on paper or wait for letters, and can obtain mortgage loans, purchase insurance or sign contracts with house building merchants through internet without stepping out of door; enterprises also can reach legally effective agreements with each other through online negotiation. But, current digital signature technology can be applied only in electronic files, but can do nothing for common files. In fact, since e-commerce is not so popular at present, most formal documents and agreements still need hand-writteni signatures and seals that are physical in nature. This greatly restricts application of digital signature. In this invention, by using digital watermark technology, digital signature is seamlessly integrated into digital or paper files, and can resist common image distortions. Since digital watermark algorithm provided in this invention has very high robustness, we still can effectively extract watermark information from the watermarked files after common printing, faxing and scanning, then we can obtain original signature, thus making printed and faxed files also have legal effect. As a new digital anti-counterfeit method, this invention greatly enhances anti-counterfeit function of formal files, credentials, trademarks and business contracts. What is more safely, this invention can perfectly combine with existing written signature and seal, and perfectly embed digital signature into written signature and seal image through watermarking, thus making valuable files or credentials have dual guarantee effect of both written signature and digital signature.

### ILLUSTRATIONS ON ACCOMPANYING DRAWINGS

FIG. 1 is flow chart of watermark embedding algorithm

FIG. 2 is flow chart of watermark detection algorithm

FIG. 3 is watermarking example, the three pictures are respectively the original image, watermarked image and watermark

FIG. 4 is flow chart of encryption algorithm

FIG. 5 is flow chart of public key algorithm

FIG. 6 is schematic diagram of digital signature

FIG. 7 is flow chart of fabricating digital anti-counterfeit files

FIG. 8 is flow chart of verifying digital anti-counterfeit files

FIG. 9 is example of realizing digital credentials

FIG. 10 is schematic diagram of realizing digital seal

FIG. 11 is example of digital seal

FIG. 12 is schematic diagram of detecting digital anti-counterfeit seal

FIG. 13 is schematic diagram of digital written signature

FIG. 14 is example of digital written signature

FIG. 15 is example of fabricating digital trademark

FIG. 16 is example of realizing digital barcode

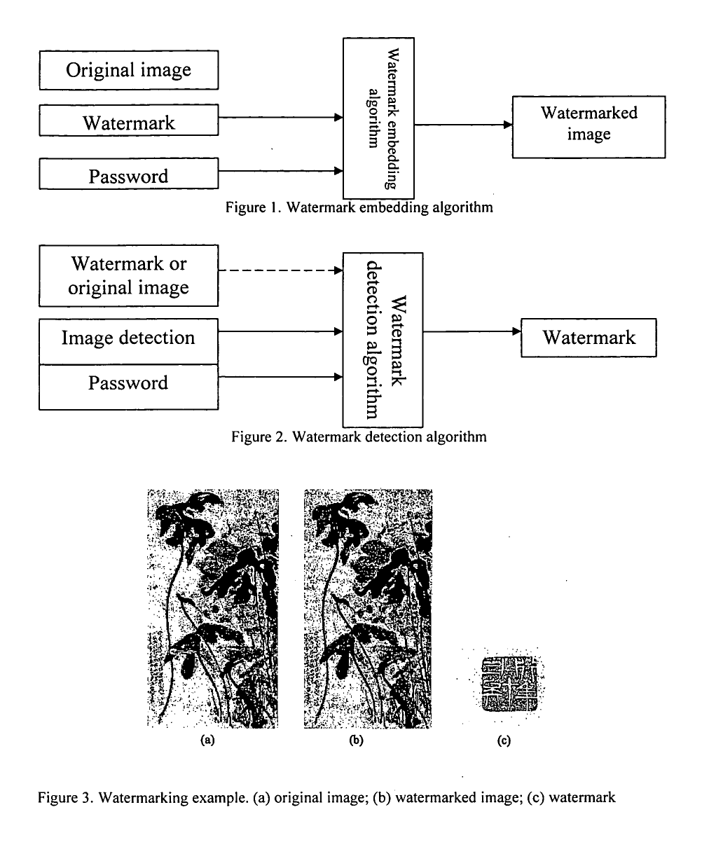

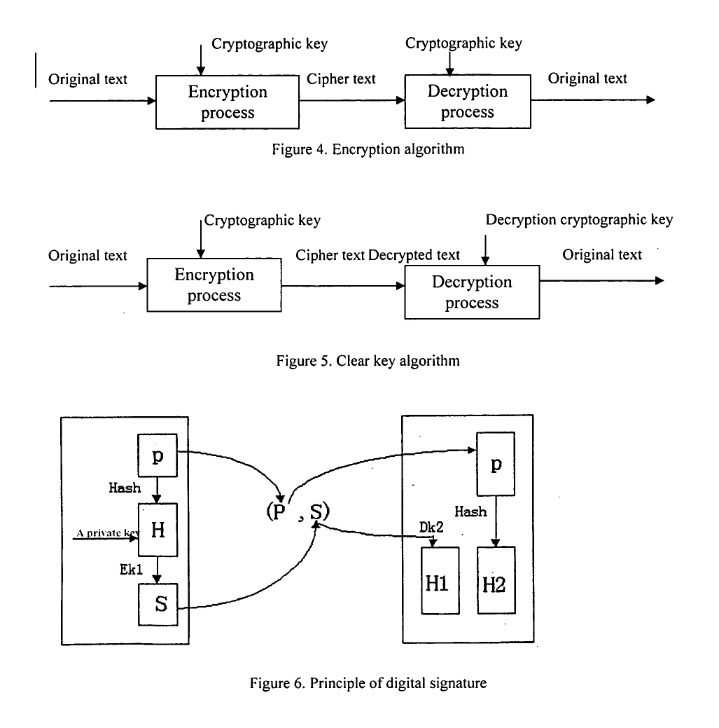

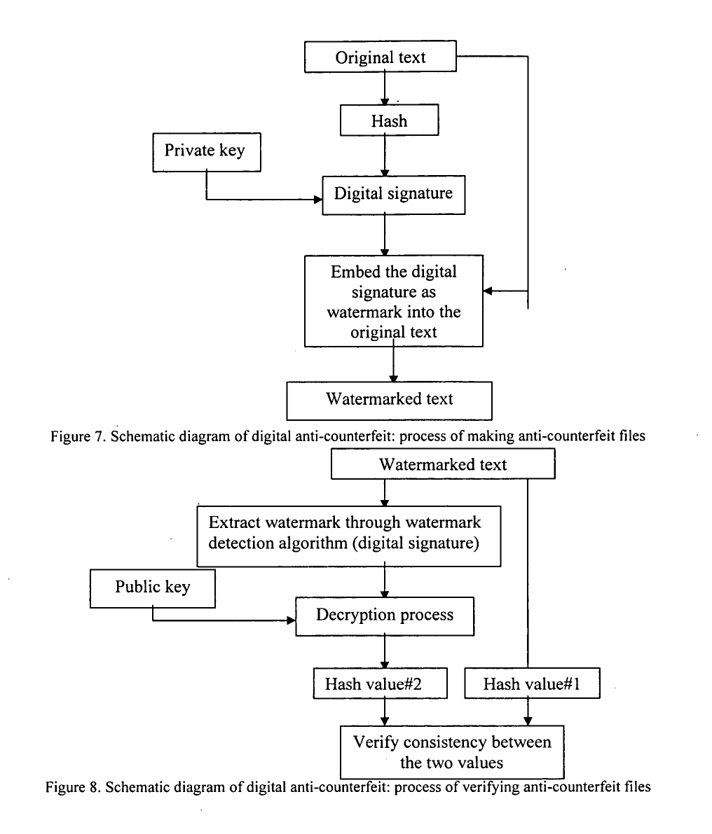

### CONCRETE IMPLEMENTATION METHODS

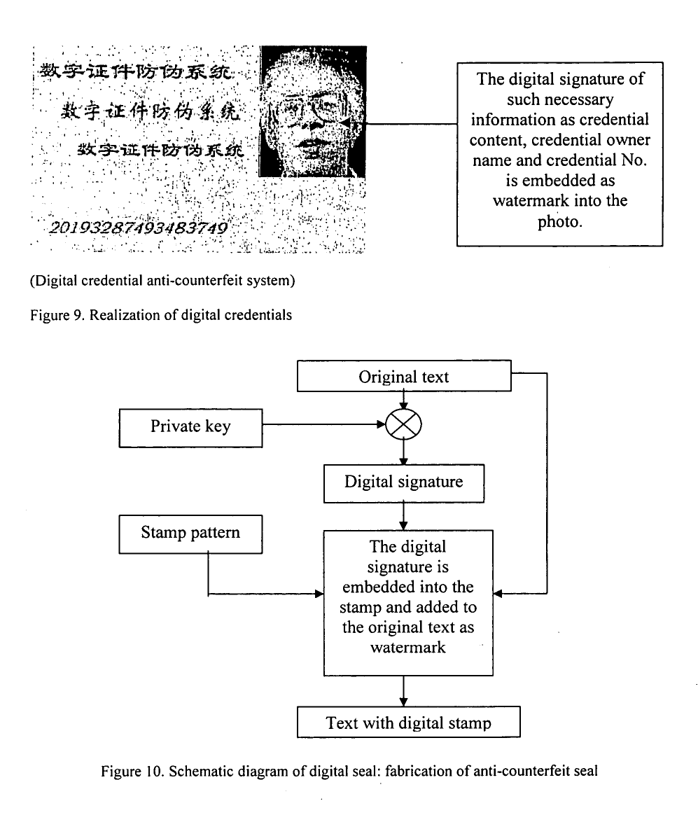

I. Method for realization of anti-counterfeit of digital credentials. This method can use digital watermarking to realize Anti-counterfeit of various credentials such as ID card, marriage certificate and diploma. Firstly obtain Hash value corresponding to valid information in the credential through Hash function, including name of the credential holder, credential No., issuing date, valid period, issuing authority, etc. (also some other important information), make digital signature by encrypting Hash value with the private key of issuing authority, then embed the signature information into the head portrait of credential via watermarking algorithm. Every issued credential contains head portrait with watermarked signature. As shown in FIG. 9, for a credential requiring verification of authenticity, signature information in the watermark can be used to verify whether its head portrait contains corresponding digital signature, thus realizing Anti-counterfeit purpose. For example, the process of making ID card is to scan the photo and make signature, embed the signature into the photo, then input the electronic image containing digital signature into the credential-making machine, print and plastic-envelop the credential. The ID card thus made contains a hidden digital watermark (i.e. digital signature of credential). To be specific, modify some unnoticeable parts on the photo. If observed with naked eye, the processed photo has little impact on human visual system. However, after scanning, watermarking information in the photo can be extracted, then public key of issuing authority can be used to verify digital signature, so as to judge the authenticity of credential.

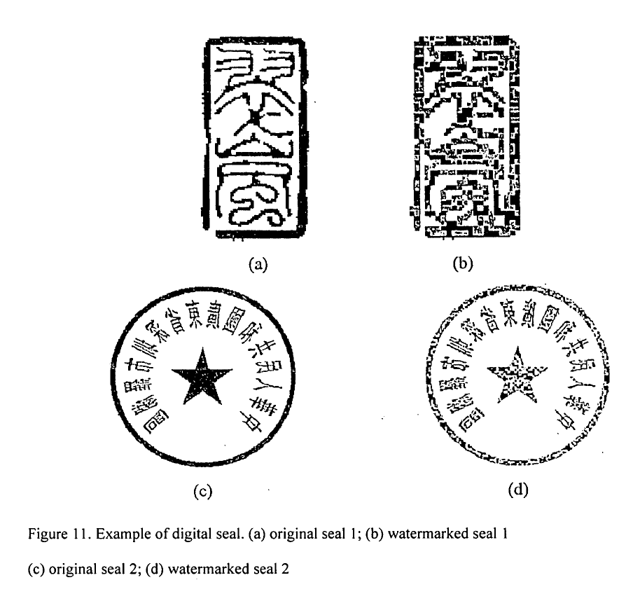

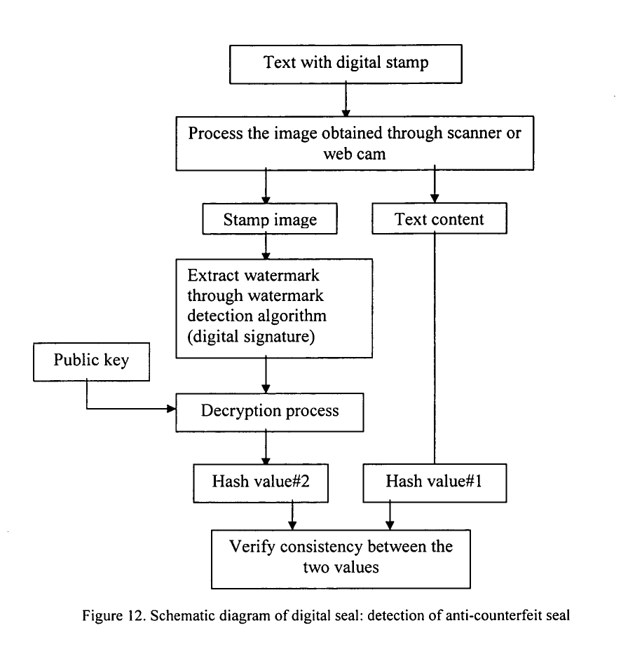

II. Method for realization of digital seal and digital written signature. Anti-counterfeit of seal and written signature is very important, because they are effective legal evidence for all formal files, credentials and contracts. But normal seal and written signatures are also faced with counterfeit problem. In our country, seals are used as effective identification for governmental files, company contracts, etc., but counterfeit of seals is very easy, so how to effectively eliminate the counterfeit of seals is a problem to be solved the sooner the better. Currently, many seal anti-counterfeit systems start with the process of fabricating seals, and its anti-counterfeit function can be realized only under the condition that ordinary counterfeiters don't have tools and techniques for fabricating seals. But in fact this kind of anti-counterfeit system is very fragile. In this invention, digital watermark technology is used to embed digital signature of the file into its seal and written signature so that the file has dual anti-counterfeit effect of digital signature and seal (or written signature), and in principle it cannot be counterfeited. The flow of surcharging digital seals is as shown in FIG. 10. Firstly extract digital signature of original text, then embed the signature as digital watermark into seal pattern (see FIG. 11 for seal pattern before and after processing), and surcharge on original text, thus obtaining text with digital signature seal. Identification of seals is also very simple. What needs to be done is just to place the text to be identified into common scanner or web cam to read scanned image of the text, identifying the script content and seal pattern of the text, then compare the two Hash values calculated to see if they are consistent according to flow in FIG. 12. Therefore, watermarked text after printing, copying and faxing still has the same effect as the original.

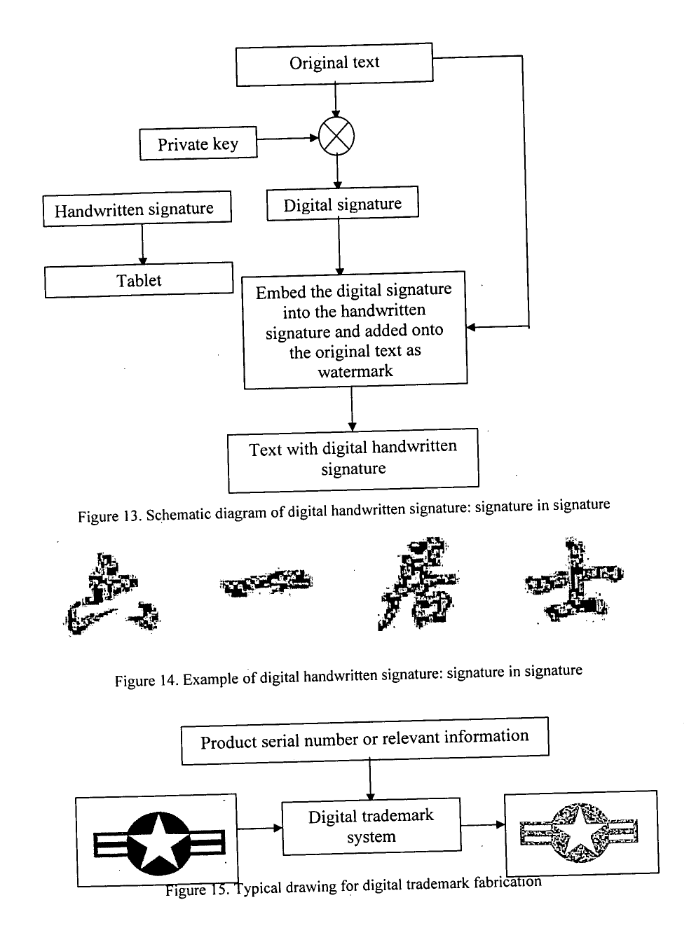

Principle of digital hand-written signature is similar to that of digital seal. The difference is that the signer of a file signs on a writing tablet, and the hand-written signature image is automatically watermarked in computer, and then output to the file. See FIG. 13 for its flow chart. Watermarked hand-written signature image -obtained in this way can be called “signature in signature” (FIG. 14). Actually, its anti-counterfeit performance is better than that of digital seal. Method for detection of signature is similar to that of digital seal.

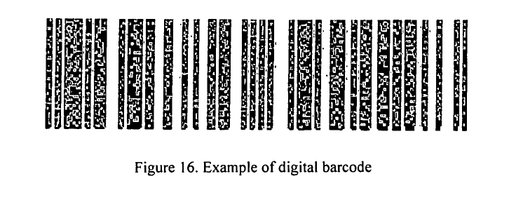

III. Method for realization of digital trademark anti-counterfeit. A natural application of this invention is to apply it in trademark anti-counterfeit, i.e. method for digital trademark anti-counterfeit. Its principle is exactly the same as that of the previous digital seal. Firstly make digital signature for serial number of each product, then embed the signature as watermark into the trademark (FIG. 15). Trademark authentication is relatively -easier. Scan the trademark pattern into computer through scanner or web camera, extract watermark using watermark detection algorithm, then verify authentication -of the trademark digital signature with public key published by manufacturer of the product. Anti-counterfeit of digital trademark is based on two pre-conditions: (1) nobody can make this trademark, i.e. only the manufacturer can make product trademark, and technology of digital signature guarantees this; (2) the counterfeiter can counterfeit a commodity only by duplicating the trademark already made. For counterfeit in a big way, under the condition that digital signatures of different products are different, actually it is very uneconomical and difficult.

IV. Method for signature of digital barcode. It is also possible to directly convert the serial number of a file, credential or commodity into barcode, and signature of serial number can be directly embedded into barcode, thus constituting a method for realizing signature of digital barcode. In this way, it can be very convenient to effectively combine the existing barcode technology with digital anti-counterfeit in this invention, as shown in FIG. 16.

1. A digital anti-counterfeit method based on digital watermark technology, whose feature consists in embedding the digital signature or other anti-counterfeit information of the file into host medium, so as to realize such functions as anti-counterfeit and verification of various important files, business contracts, individual credentials, trademarks and barcodes, in physical form (print, paper, label, etc) and digital form (such formats as PDF, WORD and XML).

2. A digital anti-counterfeit method described according to claim 1, whose feature consists in making block DCT conversion of images, embedding the multi-bit information into the image through additive watermark embedding model \overline{c}ₖ=cₖ+aₖw_{k,} among which, C={cₖ, k=1,2, . . . ,K}is characteristic vector of the image, \overline{C}={\overline{c}ₖ} εF^{K} is new characteristic vector, and { aₖ} is the constant vector that controls the watermark embedding intensity or energy. Detection process of watermarking gives symbol related detection algorithm
$$Z = {\sum }_{k} {w}_{k} \cdot sgn ( {\tilde{c}}_{k} )$$
under the assumption that image DCT coefficient meets Laplacian distribution, and perform hypothesis test according to Nayman-Pearson criterion, thus obtaining watermark information.

3. A digital anti-counterfeit method described according to claim 1, whose feature consists in bringing up a very robust watermark embedding and detection algorithm for two-valued or multi-valued image. Information is directly embedded into null field of image according to K (block size), Q(image quality coefficient) and image size. Its algorithm is: scan the image from top to bottom, divide it into N image blocks according to image content, calculate scalar quantity
$${S}_{i , j}^{k} = {\sum }_{k} {\sum }_{k} {a}_{i + k , j + k} .$$
Determine whether to embed watermark information according to S_{i,j}^{k} value. When watermark information is 1, set a_{i+k,j+k}=128; when watermark information is 0, set a_{i+k,j+k}=128. Block shape can be square, round point or other feature pattern, number of pixel points in each block depends on concrete application, the less pixel points, the more blocks, and the more embeddable information. Each block can be embedded with information of one bit or multiple bits according to different needs (the higher the image gray scale, the more the bits, and if block image only has one gray scale, each block can only be embedded with one-bit information). Watermark detection algorithm is a simple reverse process. For image watermark algorithm of each KB XKB block, it can be regarded as watermark verification instead of watermark extraction algorithm, i.e. judging whether image block contains watermark. In fact, it can also be regarded as watermark recovery algorithm of bit information. Therefore, if there are N image blocks, the image can be embedded and detected with N bits of information.

4. A digital anti-counterfeit method described according to claim 1, whose feature consists in dividing image into small blocks (ex. square block, round point or other feature pattern), according to features like color, shape and position, etc. of image element (parts where light reflection rate is lower, ex. black “line”), each block can be embedded with information of one or more bits according to different needs. For each block, visibility of watermark information and quantity of embedded information is determined through predefined color value setting (including color value and gray scale).

5. A digital anti-counterfeit method described according to claim 1, whose feature consists in converting content of original file into corresponding Hash value through Hash function; obtain digital signature of original file from Hash value through public key encryption algorithm; then embed the digital signature as watermark information into original file to obtain anti-counterfeit file containing digital signature. It can be judged whether the file is counterfeited by verifying digital signature. The process of judgment is to firstly obtain Hash value Hash #1 of file content to be judged, then extract digital signature information from watermark information to obtain original Hash value Hash #2, and if the two values are not the same, the file is counterfeited.

6. A digital anti-counterfeit method described according to claim 1, whose feature consists in its ability to realize digital anti-counterfeit of valid credential through digital watermark and digital signature algorithm, obtain digital signature of content from valid information of credential (ex. name of credential holder, credential number, issuing date, valid period, issuing authority, etc. as well as some other important information), then embed the signature information into the head portrait of credential through watermark algorithm described in right claim 2, enabling each issued credential to contain head portrait with watermark signature. Authenticity of credential can be identified by extracting digital signature information from watermark.

7. A digital anti-counterfeit method described according to claim of right 1, whose feature consists in its ability to realize digital anti-counterfeit function of ordinary seal and written signature through digital watermark and digital signature algorithm. Embed digital signature of the file into seal and written signature of the file through watermark algorithm, enabling files to have dual anti-counterfeit effect of both digital signature and seal (or written signature), and enabling files to still have legal effect of the original even after printing, copying and faxing.

8. A digital anti-counterfeit method described according to claim 1, whose feature consists in its ability to realize the digital anti-counterfeit of trademarks through digital watermark and digital signature algorithm. Make digital signature from serial number or other valid information of each product, then embed the signature as watermark into trademark. In the verification process, obtain trademark pattern through ordinary scanner or web cam, then extract digital signature from watermark information, and verify its authenticity.

9. A digital anti-counterfeit method described according to claim 1, whose feature consists in its ability to fabricate general anti-counterfeit label through a one dimensional watermark barcode, two-dimensional barcode and two-dimensional watermark barcode. Print the barcode with encryption or signature information on the anti-counterfeit label, then authenticity of any label at validation end can be confirmed through public key of the encrypter, without support from verification data center or other data bases. Such anti-counterfeit label can be made with one-dimensional watermark barcode, two-dimensional barcode or two-dimensional watermark barcode, and can be applied in situations where it is necessary to verify authenticity of files, commodities and other data.

10. A digital anti-counterfeit method described according to claim 1, whose feature consists in graphic treatment of digital signature or anti-counterfeit information. Convert such digital watermark information as digital signature or anti-counterfeit information into graphic and image form (ex. seal, written signature, picture, curved line, image, etc.), and embed into electronic document (file formats such as PDF, WORD, image and video), multimedia data (image, video) and paper document. In this way, digital signature or anti-counterfeit information can exist in electronic and paper documents in the form of mimic and visualized graphics and images instead of nonfigurative binary codes. In this way, watermark detection and authenticity verification can be done directly for watermarked host medium.

11. A digital anti-counterfeit method described according to claim 1, whose feature consists in its ability to compose a complete watermark fabrication, transmission and verification system through graphic digital signature or anti-counterfeit information. The fabrication end is to embed the digital watermark containing digital signature or other information into host data, and can output text of physical (ex. paper) or digital medium (ex. Adobe PDF). The transmission end is to send carriers containing graphic digital watermark to the demander in different ways (ex. sending electronic text via internet, sending common paper text via mail, etc.). The validation end is to perform watermark detection for received carrier medium (electronic or physical form), and judge whether this carrier contains valid digital watermark information. Such a system can be in purely digital form (ex. embed such watermark information as graphic digital signature into Adobe PDF file, and transmit the PDF file to the remote receiving end, then verify watermark information in the electronic file directly at the receiving end. Of course, this is also applicable to electronic texts in other various forms); also can be in digital/physical mixture form (ex. only the fabrication end is electronic form, the output PDF file is printed on paper and transmitted to receiving party, and at the receiving end paper file can be converted into image form through such login devices as web cam or scanner, then verify its watermark information).

12. A digital anti-counterfeit method described according to claim 1, whose feature consists in its ability to directly online generate electronic files with legal effect through a complete watermark fabrication, transmission and verification system composed of graphic digital signature. Electronic files containing graphic digital signature are self-contained, and all information of digital signature will be reserved even after text format conversion or after printing to paper through direct output device.
